(19) United States
(12) Patent Application Publication
(10) Pub. No.: US 2026/0370930 A1
(43) Pub. Date: Nov. 19, 2026

(54) ENHANCED MOBILE INDUSTRY PROCESSOR INTERFACE (MIPI) CAMERA AUTO DETECTION FOR REPLACEMENTS

(71) Applicant: Intel Corporation, Santa Clara, CA (US)

(72) Inventors: Jianxin Fan, Beijing (CN); Henry Chang, New Taipei City (TW); Neil Yn Chang, Beijing (CN); Wentao Han, Beijing (CN)

(73) Assignee: Intel Corporation, Santa Clara, CA (US)

(21) Appl. No.: 19/135,328

(22) PCT Filed: Jan. 4, 2023
(86) PCT No.: PCT/CN2023/070434

§ 371 Date: Jun. 3, 2025

(51) Int. Cl. H04N 23/617; G06F 9/4401; H04N 23/65

(52) U.S. Cl. CPC H04N 23/617; G06F 9/4411; H04N 23/65

(57) ABSTRACT

This disclosure describes systems, methods, and devices related to detecting and initializing Mobile Industry Processor Interface (MIPI) cameras. A system may include a virtual MIPI camera module of a BIOS, the virtual MIPI camera module comprising Advanced Configuration and Power Interface (ACPI) descriptions of MIPI camera modules; a virtual MIPI camera module driver configured to automatically detect the MIPI camera modules and load corresponding MIPI camera driver runtimes; and an auto detection backend of MIPI camera module drivers, the auto detection configured to power on and off a physical MIPI camera, and to match a device or module identifier of the physical MIPI camera to an ACPI description of the ACPI descriptions.

### TECHNICAL FIELD

This disclosure generally relates to devices, systems, and methods for detecting cameras connected to a device, and more particularly, to detecting Mobile Industry Processor Interface (MIPI) cameras connected to a device.

### BACKGROUND

Computer manufacturing may include the integration of multiple parts, such as the connection of a camera to a host device. Often, a manufacturer may use single-source camera modules for a specific product. However, due to supply chain and other changes, manufacturers may need to be able to replace one type of camera with another type of camera.

### BRIEF DESCRIPTION OF THE DRAWINGS

FIG. 1 illustrates an example system architecture for auto detection of Mobile Industry Processor Interface (MIPI) camera modules, in accordance with one or more example embodiments of the present disclosure.

FIG. 2 illustrates an example process flow for auto detection of MIPI camera modules, in accordance with one or more example embodiments of the present disclosure.

FIG. 3 illustrates an example camera structure, in accordance with one or more example embodiments of the present disclosure.

FIG. 4A shows an example USB camera module, in accordance with one or more example embodiments of the present disclosure.

FIG. 4B shows an example MIPI camera module, in accordance with one or more example embodiments of the present disclosure.

FIG. 5 illustrates a flow diagram of an illustrative process for auto detection of MIPI camera modules, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

In the past, original equipment manufacturers (OEMs) usually sourced a single camera module for a specific product from one vendor. Today, to ensure production to the market, OEMs have to consider sourcing multiple camera modules (for example, three camera module candidates A, B, C with the same capability from one or multiple vendors are planned to integrate as single User Facing camera on a laptop). That means an OEM needs replace one camera module with another when a camera module is no longer available, and an OEM may need to replace a camera module seamlessly without any additional change (e.g., hardware, software, or other configuration) to maintain efficiency of a manufacturing line and save management cost.

A camera module replacement using a USB camera module may provide some benefits because a USB camera is a standalone device and does not have any dependency on the host to recognize and use the camera seamlessly. In particular, 1) a USB camera is a UVC (Universal Video Class) device that can be recognized by a USB bus controller, and 2) it can be initialized by the OS (Operating System) built-in UVC driver automatically.

However, MIPI camera modules have a dependency on a BIOS ACPI (Basic Input and Output System, Advanced Configuration and Power Interface) description and a specific software driver for the host system to recognize and initialize the MIP camera modules, even though the MIPI Alliance has defined specifications to simplify MIPI device design and integration. As a result, when replacing one MIPI camera module with another, the replacement MIPI camera module may not be recognized/initialized seamlessly without updating the BIOS ACPI description and the MIPI camera module software driver. The replacement with a MIPI camera module may pose challenges when an OEM plans to adopt an IPU (Image Processing Unit) with multiple MIPI camera module supply chains, for example, which may impacts an IPU attach rate (e.g., for attaching the MIPI camera modules to the host).

Some techniques for recognizing and initializing MIPI camera modules include the use of a GPIO (general-purpose input/output) Switch for BIOS to identify which MIPI camera module is being used. When BIOS receives a GPIO “ON” state, it means that a first camera is used, then BIOS updates a ACPI table with a description of the first camera. More GPIO switches are required when there are more MIPI camera module candidates to be used (e.g., to recognize the different types of MIPI camera module candidates), and all camera descriptions are pre-coded in BIOS for a “GPIO State Detector” to select.

Another set of techniques for recognizing and initializing MIPI camera modules include relies on a BIOS program to perform auto detection, in which all camera descriptions are pre-coded in BIOS, during BIOS initialization when the system boots. BIOS powers up a camera module, then attempts to identify the camera module one by one until it matches with a MIPI camera hardware ID, then updates the BIOS ACPI description. In addition, all software drivers of the MIPI camera module candidates are required to be pre-installed in the OS.

Another set of techniques for recognizing and initializing MIPI camera modules a hardware configuration relying on an external chip (usually called EC-Embedded Controller) and storage (such as EEPROM). Each platform and camera module is a unique combination, and the camera ACPI description is stored in the EEPROM. The EC reads the EEPROM, then BIOS updates the ACPI description table accordingly. All software drivers of MIPI camera module candidates are required to be pre-installed in the OS.

However, the existing set of techniques for recognizing and initializing MIPI camera modules are not scalable solutions. In particular, the GPIO switch techniques introduce an additional GPIO switch for each candidate MIPI camera module, which adds significant cost and GPIO design complexity to accommodate multiple MIPI camera module candidates. The BIOS program techniques rely on complicated auto-detection because each camera module may have a different power sequence which usually is implemented by a software driver running in the OS. The BIOS program techniques also may not work when a companion chip is used between a camera module and IPU for pre-processing because BIOS is not able to implement complicated programs to operate with the companion chip. The hardware configuration techniques may require significant hardware changes with the EC and EEPROM, increasing cost and relying on a manufacturing process to pair a platform with a camera module one-by-one (e.g., difficult to implement on an assembly line).

In one or more embodiments, the enhanced MIPI camera recognition techniques herein create a virtual MIPI camera object in BIOS, and decouples dependency between BIOS ACPI description and OS. The MIPI camera detection (e.g., recognition and virtualization) may be performed by software. The ACPI description of a virtual MIPI camera may describe a virtual MIPI camera module to the OS, the corresponding ACPI description has a custom device identifier and maintains a resource declaration (e.g., GPIO and I2C resource), the same as a real MIPI camera module. The software driver of the virtual MIPI camera may be a driver wrapper of a real MIPI camera module. The OS loads the software driver of the MIPI camera during a system boot or when the end user performs a driver installation. The software driver may perform MIPI camera module auto detection and build a connection to a real MIPI camera module driver. An auto detection backend may be a software function block in each real MIPI camera module driver, and may attempt to power up a real camera module to verify device identifiers and/or module identifiers.

The enhanced MIPI camera recognition techniques herein provide an economic and real scalable solution to recognize and initialize MIPI camera modules seamlessly, and does not require any change when an OEM replaces one MIPI camera module with another, eliminating the MIPI camera module auto recognition limitation (e.g., compared to a USB camera module), which can help increase an IPU attach rate.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

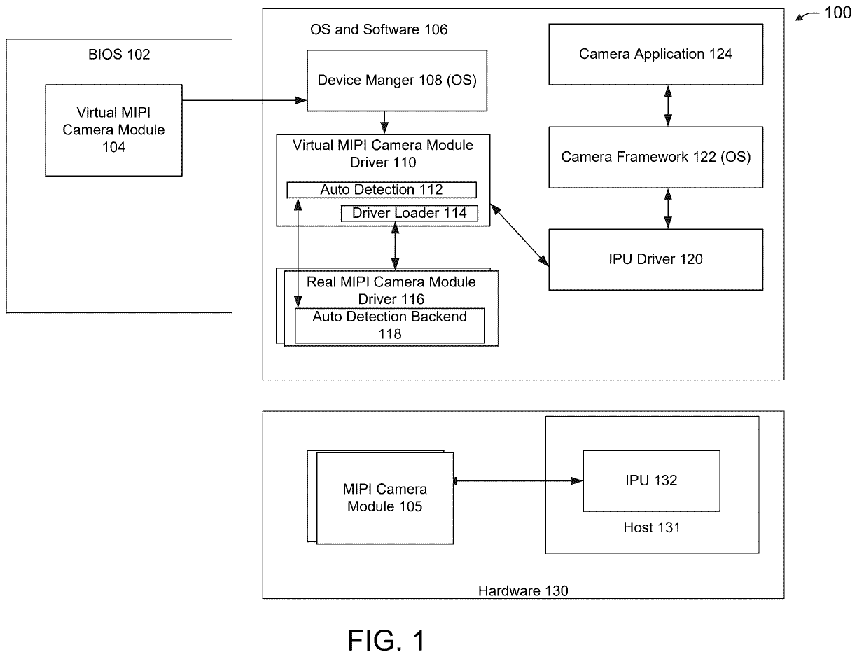

FIG. 1 illustrates an example system architecture 100 for auto detection of MIPI camera modules, in accordance with one or more example embodiments of the present disclosure.

Referring to FIG. 1, the system architecture 100 may include a BIOS 102 with a virtual MIPI camera module 104 for a hardware MIPI camera module 105. The virtual MIPI camera module 104 may include an ACPI description in the BIOS 102. An OS and software 106, using a device manager 108 (e.g., OS), may read the ACPI description of the virtual MIPI camera module 104 from the BIOS 102. The device manager 108 may recognize and initialize a virtual MIPI camera and load a virtual MIPI camera module driver 110 (e.g., having an auto detection 112 to detect, and a real MIPI camera and a driver loader 114 to load, a real MIPI camera module driver 116 having an auto detection backend 118). An IPU driver 120 may be integrated with a camera framework 122 (e.g., OS), and a camera application 124 using the connected MIPI camera. Hardware 130 may include the hardware MIPI camera module 105 and a host 131 (e.g., system on chip) with an IPU 132. The virtual MIPI camera module 104, the virtual MIPI camera module driver 110, and the auto detection backend 118 may allow for recognizing and initializing multiple of the hardware MIPI camera modules (e.g., for MIPI cameras 1-N), allowing for seamless replacement of a MIPI camera with another MIPI camera.

In one or more embodiments, the virtual MIPI camera module 104 may include an ACPI description of the MIPI camera module 105 in the BIOS 102, the ACPI description having a dedicated custom hardware identifier. Below is example BIOS ACPI source language code that may be used for the ACPI description:

```
  Scope(\_SB.PCI0.I2C0)
  {
    Device(CAM0)
    {
      // Example of custom hardware ID description
      Name(_HID, “IVC1234”)
      Name(_SUB, “Intel”)
      Name(_DDN, “Intel-VC”)
      ... ...
      // Example of declaring hardware resources required by real MIPI
camera module
      Method(_CRS, 0x0, NotSerialized)
      {
        Name(SBUF, ResourceTemplate( )
        {
          I2CSerialBus(0x0036, ControllerInitiated, 0x00061A80,
AddressingMode7Bit,
          “\\_SB.PCI0.12C0”, 0x00, ResourceConsumer,,)
        })
        Return (SBUF)
      }
      ... ...
  }
```

In one or more embodiments, the virtual MIPI camera module driver 110 may, when the OS is Windows, for example, be implemented as a Windows Driver Framework. In one example, the following driver callback interfaces may be implemented for both the virtual MIPI camera module driver 110 and the real MIPI camera module driver 116:
DRIVER_INITIALIZE DriverEntry
EVT_WDF_DRIVER_DEVICE_ADD EvtDeviceAdd
EVT_WDF_DRIVER_UNLOAD DriverUnload
EVT_WDF_OBJECT_CONTEXT_CLEANUP EvtDriverContextCleanup
EVT_WDF_DEVICE_D0_ENTRY EvtDeviceD0Entry
EVT_WDF_DEVICE_D0_EXIT EvtDeviceD0Exit
EVT_WDF_DEVICE_PREPARE_HARDWARE EvtDevicePrepareHardware
EVT_WDF_DEVICE_RELEASE_HARDWARE EvtDeviceReleaseHardware
EVT_WDF_DEVICE_QUERY_REMOVE EvtDeviceQueryRemove

In one or more embodiments, the auto detection 112 may be implemented inside EvtDevicePrepareHardware function, and the “Auto Detection” may be performed when EvtDevicePrepareHardware gets called by the OS after a hardware resource (i.e., GPIO and I2C) assigned. When the real MIPI camera module 116 is recognized by the auto detection 112, the driver loader 114 builds a final connection between the virtual MIPI camera module driver 110 and the real MIPI camera module driver 116.

In one or more embodiments, the virtual MIPI camera module driver 110 installation file may use a custom hardware identifier. Below is an example portion of a sample virtual MIPI camera module driver 110 installation file:

[Version]
Signature=“$WINDOWS NT$”
Class=System
ClassGuid={4D36E97D-E325-11CE-BFC1-08002BE10318}
Provider=%INTEL%
DriverVer=08/10/2022,6.2.7989.0
CatalogFile=ivcref.cat
...
%IVCREF.DeviceDesc%=IVCREF_Device,
ACPI\VEN_IVC&DEV_1234&SUBSYS_ENTITY
...
[Strings]
SPSVCINST_ASSOCSERVICE = 0x00000002
ENTITY = “ ENTITY Corporation”
IVCREF = “ ENTITY Camera Ref”
DiskId1 = “ ENTITY Camera Ref Installation Disk #1”
IVCREF.DeviceDesc = “ ENTITY Camera Ref”
IVCREF.SVCDESC = “ ENTITY Camera Ref”

In one or more embodiments, the auto detection backend 118 may be implemented as a software function block that may attempt to power on the real MIPI camera module 116, then read the device identifier and/or module identifier to distinguish between which MIPI camera module is actually being used. In a scenarios in which two different MIPI camera modules integrate with the exact same image sensor, a module vendor may have a Module ID stored in the MIPI camera module, for example, usually stored in NVM (Non-volatile Memory) of the MIPI camera module.

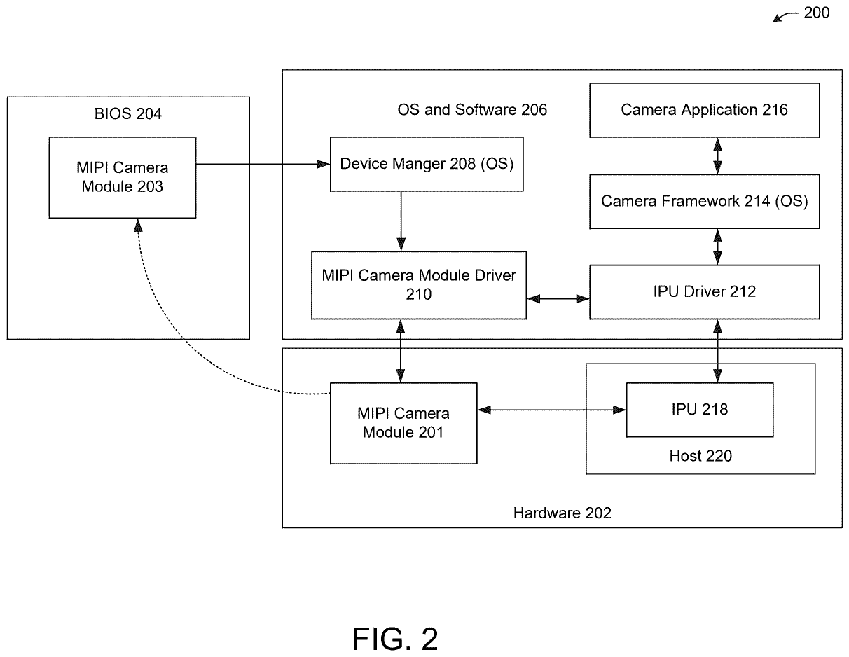

FIG. 2 illustrates an example process flow 200 for auto detection of MIPI camera modules, in accordance with one or more example embodiments of the present disclosure.

Referring to FIG. 2, a MIPI camera module 201 in hardware 202 may have an ACPI description written into a MIPI camera module 203 in BIOS 204. An OS and software 206 may read the ACPI description from the BIOS 204 with a device manager 208, which may recognize and initialize the MIPI camera, and load the corresponding software driver (e.g., using a MIPI camera module driver 210). The OS and software 206 may include an IPU driver 212, camera framework 214 (e.g., OS), and a camera application 216 for using the MIPI camera. The hardware 202 may include a host 220 (e.g., system on chip).

In one or more embodiments, when replacing one MIPI camera module 210 with another, the BIOS 204 needs to be updated with the corresponding ACPI description and MIPI camera module software driver, in contrast with the seamless transition provided by the system architecture 100 of FIG. 1.

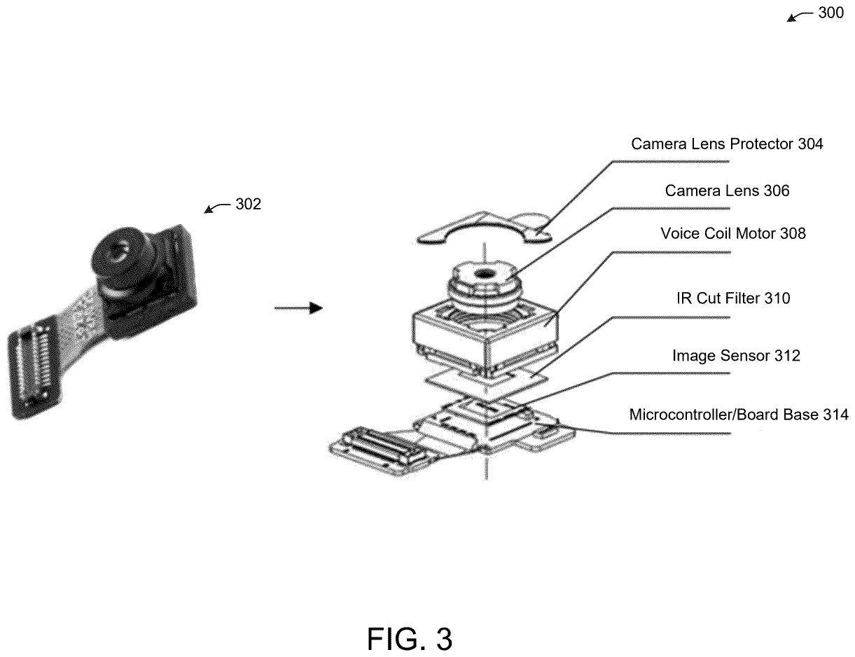

FIG. 3 illustrates an example camera structure 300, in accordance with one or more example embodiments of the present disclosure.

Referring to FIG. 3, a camera 302 may include components such as a camera lens protector 304, a camera lens 306, a voice coil motor 308, an IR cut filter 310, an image sensor 312, and a microcontroller/board base 314. When the image sensor 312 is the same for different cameras, a module of the camera 302 (e.g., the MIPI camera module 105 of FIG. 1) may include a unique device or module identifier.

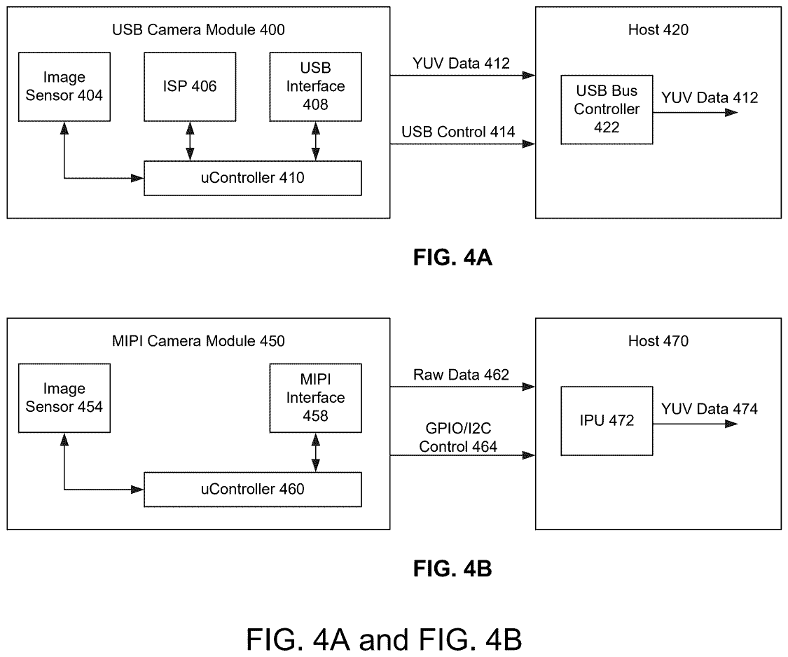

FIG. 4A shows an example USB camera module 400, in accordance with one or more example embodiments of the present disclosure.

Referring to FIG. 4A, the USB camera module 400 may include an image sensor 404 (e.g., corresponding to the image sensor 312 of FIG. 3), and ISP 406, a USB interface 408, and a ucontroller 410. The USB camera module 400 may send YUV pixel data 412 from images captured by the image sensor 404, along with USB control information 414, to a host 420 (e.g., system on chip), which may include a USB bus controller 422 for sending the YUV pixel data 412.

FIG. 4B shows an example MIPI camera module 450, in accordance with one or more example embodiments of the present disclosure.

Referring to FIG. 4B, the MIPI camera module 450 may include an image sensor 454 (e.g., corresponding to the image sensor 312 of FIG. 3), a MIPI interface 458, and a ucontroller 460. The MIPI camera module 450 may send raw pixel data 462 captured by the image sensor 454, along with GPIO/I2C control information 464, to a host 470 (e.g., system on chip) having an IPU 472 to process raw pixel data then output YUV pixel data 474 to an application (e.g., the camera application 124 of FIG. 1).

Referring to FIGS. 4A and 4B, USB cameras may be replaced easily because the USB bus controller 422 may recognize the USB camera module 400 as a universal video class, and the OS of the host 420 may initialize the USB camera module 400 using a built in UVC driver. In contrast, the MIPI camera module 450 cannot be recognized and initialized in the same manner because the MIPI camera module 450 has a dependency on BIOS ACPI description and a specific software driver. Accordingly, the system architecture 100 of FIG. 1 may be implemented to allow for seamless replacements of different MIPI cameras.

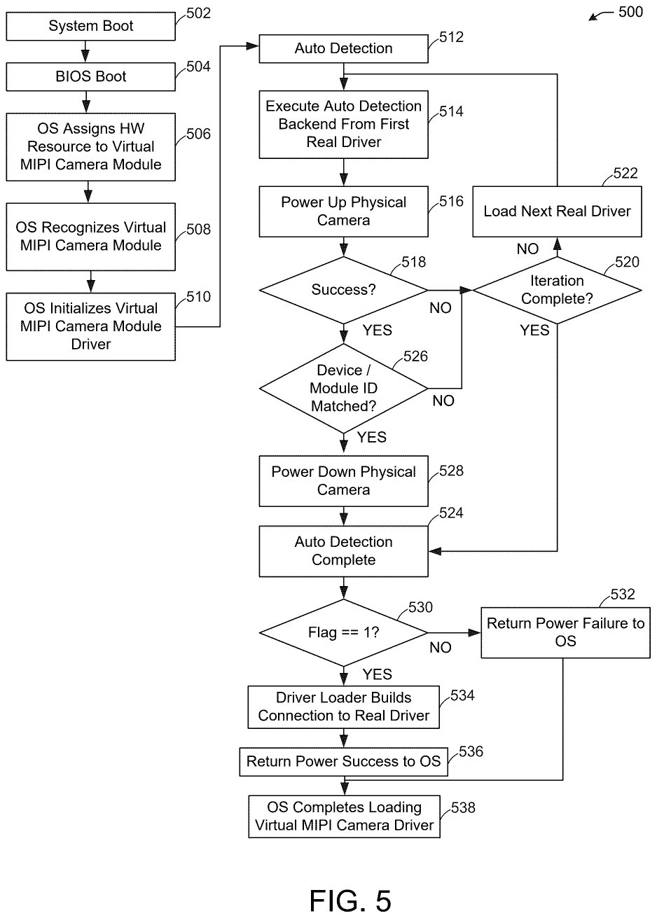

FIG. 5 illustrates a flow diagram of an illustrative process 500 for auto detection of MIPI camera modules, in accordance with one or more example embodiments of the present disclosure.

At block 502, a system (e.g., using the system architecture 100 of FIG. 1) may boot, and the BIOS (e.g., the BIOS 102 of FIG. 1) may boot at block 504. At block 506, an OS (e.g., the OS and software 106 of FIG. 1) may assign hardware resources to a virtual MIPI camera module (e.g., the virtual MIPI camera module 104 of FIG. 4). At block 508, the OS may recognize the virtual MIPI camera module. At block 510, the OS may initialize the virtual MIPI camera module driver (e.g., the virtual MIPI camera driver 110 of FIG. 1). Then, at block 512, auto detection may begin. At block 514, an auto detection backend (e.g., the auto detection backend 118 of FIG. 1) may execute from a first real MIPI camera driver (e.g., the real MIPI camera module driver 116 of FIG. 1). At block 516, the physical MIPI camera may be powered on. If the powering of the physical MIPI camera is not successful at block 518, when the iteration has not completed at block 520, the next real MIPI camera driver may be loaded at block 522, and the auto detection backend may be executed again at block 514. When the iteration is completed at block 520, auto detection may be completed at block 524.

When the MIPI camera has been powered on successfully at block 518, there may be a determination of whether the device identifier/module identifier of the MIPI camera matches the description. When there is a match at block 526, the physical MIPI camera may be powered down at block 528, and auto detection may be completed at block 524. When there is no match at block 526, the process 500 may return to block 520.

When the auto detection has completed at block 524, the process 500 may continue to block 530 for a determination of whether a recognized flag==1 (e.g., when the MIPI camera has been powered on). When the recognized flag is not 1, the OS may receive an indication of a power failure. When the recognized flag==1, the driver loader (e.g., the driver loader 114 of FIG. 1) at block 534 may build a connection to the real MIPI camera driver, and a power success indicator may be returned to the OS at block 536. The OS may complete the loading of the virtual MIPI camera driver at block 538.

In one or more embodiments, blocks 516, 518, 526, and 528 may be performed by the auto detection backend. Blocks 512-538 may be performed by software drivers (e.g., FIG. 1), whereas block 502-510 may be performed by the OS and BIOS.

It is understood that the above descriptions are for purposes of illustration and are not meant to be limiting.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above.

Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Various example embodiments are provided below.

Example 1 may include a system for detecting and initializing Mobile Industry Processor Interface (MIPI) cameras, the system comprising a virtual MIPI camera module of a BIOS, the virtual MIPI camera module comprising Advanced Configuration and Power Interface (ACPI) descriptions of MIPI camera modules; a virtual MIPI camera module driver configured to automatically detect the MIPI camera modules and load corresponding MIPI camera driver runtimes; and an auto detection backend of MIPI camera module drivers, the auto detection configured to power on and off a physical MIPI camera, and to match a device or module identifier of the physical MIPI camera to an ACPI description of the ACPI descriptions.

Example 2 may include the system of example 1 and/or any other example herein, wherein the virtual MIPI camera module driver comprises an auto detection configured to automatically detect the MIPI camera modules, and a driver loader configured to load the corresponding MIPI camera driver runtimes.

Example 3 may include the system of example 2 and/or any other example herein, wherein the driver loader is further configured to build a connection to a MIPI camera module corresponding to the device or module identifier of the physical MIPI camera.

Example 4 may include the system of example 1 and/or any other example herein, wherein each of the MIPI camera module drivers corresponds to the MIPI camera modules in hardware of respective MIPI cameras.

Example 5 may include the system of example 1 and/or any other example herein, wherein the virtual MIPI camera module driver and the auto detection backend are software.

Example 6 may include the system of example 1 and/or any other example herein, wherein the ACPI description comprises the device or module identifier of the physical MIPI camera.

Example 7 may include the system of example 6 and/or any other example herein, wherein the device or module identifier of the physical MIPI camera is unique to the physical MIPI camera, and wherein a second ACPI description of the ACPI descriptions comprises a second device or module identifier of a second physical MIPI camera comprising a same image sensor as the physical MIPI camera.

Example 8 may include the system of example 1 and/or any other example herein, wherein the auto detection backend is implemented inside an EvtDevicePrepareHardware function when the EvtDevicePrepareHardware function is called by an operating system (OS) after assignment of a hardware resource.

Example 9 may include the system of example 8 and/or any other example herein, the hardware resource comprising a general-purpose input/output or an I2C resource.

Example 10 may include the system of example 1 and/or any other example herein, wherein an installation file of the virtual MIPI camera module driver comprises the device or module identifier of the physical MIPI camera.

Example 11 may include a computer-readable medium storing computer-executable instructions, associated with detecting and initializing Mobile Industry Processor Interface (MIPI) cameras, which when executed by one or more processors result in performing operations comprising: automatically detecting, using a virtual MIPI camera driver, MIPI camera modules whose Advanced Configuration and Power Interface (ACPI) descriptions are stored in a virtual MIPI camera module of a BIOS; loading, using the virtual MIPI camera driver, corresponding MIPI camera driver runtimes based on the automatic detections;

powering on, using an auto detection backend of MIPI camera module drivers, a physical MIPI camera; and matching, using the auto detection backend, a device or module identifier of the physical MIPI camera to an ACPI description of the ACPI descriptions.

Example 12 may include the computer-readable medium of example 11 and/or any other example herein, the operations further comprising: automatically detecting, using an auto detection of the virtual MIPI camera module driver, the MIPI camera modules; and loading, using a driver loader of the virtual MIPI camera module driver, the corresponding MIPI camera driver runtimes.

Example 13 may include the computer-readable medium of example 12 and/or any other example herein, the operations further comprising: building, using the driver loader, a connection to a MIPI camera module corresponding to the device or module identifier of the physical MIPI camera.

Example 14 may include the computer-readable medium of example 11 and/or any other example herein, wherein each of the MIPI camera module drivers corresponds to the MIPI camera modules in hardware of respective MIPI cameras.

Example 15 may the computer-readable medium of example 11 and/or any other example herein, wherein the ACPI description comprises the device or module identifier of the physical MIPI camera.

Example 16 may include the computer-readable medium of example 15 and/or any other example herein, wherein the device or module identifier of the physical MIPI camera is unique to the physical MIPI camera, and wherein a second ACPI description of the ACPI descriptions comprises a second device or module identifier of a second physical MIPI camera comprising a same image sensor as the physical MIPI camera.

Example 17 may include the computer-readable medium of example 11 and/or any other example herein, wherein the auto detection backend is implemented inside an EvtDevicePrepareHardware function when the EvtDevicePrepareHardware function is called by an operating system (OS) after assignment of a hardware resource.

Example 18 may include the computer-readable medium of example 17 and/or any other example herein, the hardware resource comprising a general-purpose input/output or an I2C resource.

Example 19 may include the computer-readable medium of example 11 and/or any other example herein, wherein an installation file of the virtual MIPI camera module driver comprises the device or module identifier of the physical MIPI camera.

Example 20 may include a method for detecting and initializing Mobile Industry Processor Interface (MIPI) cameras, the method comprising: automatically detecting, using a virtual MIPI camera driver, MIPI camera modules whose Advanced Configuration and Power Interface (ACPI) descriptions are stored in a virtual MIPI camera module of a BIOS; loading, using the virtual MIPI camera driver, corresponding MIPI camera driver runtimes based on the automatic detections; powering on, using an auto detection backend of MIPI camera module drivers, a physical MIPI camera; and matching, using the auto detection backend, a device or module identifier of the physical MIPI camera to an ACPI description of the ACPI descriptions.

Example 21 may include the method of example 20 and/or any other example herein, further comprising: automatically detecting, using an auto detection of the virtual MIPI camera module driver, the MIPI camera modules; and loading, using a driver loader of the virtual MIPI camera module driver, the corresponding MIPI camera driver runtimes.

Example 22 may include the method of example 21 and/or any other example herein, further comprising: building, using the driver loader, a connection to a MIPI camera module corresponding to the device or module identifier of the physical MIPI camera.

Example 23 may include the method of example 20 and/or any other example herein, wherein each of the MIPI camera module drivers corresponds to the MIPI camera modules in hardware of respective MIPI cameras.

Example 24 may include the method of example 20 and/or any other example herein, wherein the ACPI description comprises the device or module identifier of the physical MIPI camera.

Example 25 may include the method of example 24 and/or any other example herein, wherein the device or module identifier of the physical MIPI camera is unique to the physical MIPI camera, and wherein a second ACPI description of the ACPI descriptions comprises a second device or module identifier of a second physical MIPI camera comprising a same image sensor as the physical MIPI camera.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-25. (canceled)

26. An apparatus comprising:
interface circuitry;
computer readable instructions; and
at least one programmable circuit to be programmed by the computer readable instructions to:
perform automatic detections, based on a virtual Mobile Industry Processor Interface (MIPI) camera module driver, of MIPI camera modules associated with Advanced Configuration and Power Interface (ACPI) descriptions stored in a virtual MIPI camera module of a basic input/output system (BIOS);
load, based on the virtual MIPI camera module driver, corresponding MIPI camera driver runtimes based on the automatic detections;
power on, based on an auto detection backend of MIPI camera module drivers, a physical MIPI camera; and
match, based on the auto detection backend, at least one of a device identifier or a module identifier of the physical MIPI camera to a first ACPI description of the ACPI descriptions.

27. The apparatus of claim 26, wherein one or more of the at least one programmable circuit is to load, based on a driver loader of the virtual MIPI camera module driver, the corresponding MIPI camera driver runtimes.

28. The apparatus of claim 27, wherein one or more of the at least one programmable circuit is to build, based on the driver loader, a connection to a MIPI camera module corresponding to the at least one of the device identifier or the module identifier of the physical MIPI camera.

29. The apparatus of claim 26, wherein the MIPI camera modules are included in hardware of respective ones of a plurality of MIPI cameras, and the MIPI camera module drivers correspond respectively to the MIPI camera modules.

30. The apparatus of claim 26, wherein the first ACPI description includes the at least one of the device identifier or the module identifier of the physical MIPI camera.

31. The apparatus of claim 30, wherein the at least one of the device identifier or the module identifier is at least one of a first device identifier or a first module identifier that is unique to the physical MIPI camera, and a second ACPI description of the ACPI descriptions includes at least one of a second device identifier or a second module identifier of a second physical MIPI camera including a same image sensor as the physical MIPI camera.

32. The apparatus of claim 26, wherein the auto detection backend is implemented based on an EvtDevicePrepareHardware function, the EvtDevicePrepareHardware function to be called by an operating system (OS) after assignment of a hardware resource.

33. The apparatus of claim 32, wherein the hardware resource includes at least one of a general-purpose input/output or an I2C resource.

34. The apparatus of claim 26, wherein an installation file of the virtual MIPI camera module driver includes the at least one of the device identifier or the module identifier of the physical MIPI camera.

35. An article of manufacture comprising computer-readable instructions to cause at least one programmable circuit to at least:
perform automatic detections, based on a virtual Mobile Industry Processor Interface (MIPI) camera module driver, of MIPI camera modules associated with Advanced Configuration and Power Interface (ACPI) descriptions stored in a virtual MIPI camera module of a basic input/output system (BIOS);
load, based on the virtual MIPI camera module driver, corresponding MIPI camera driver runtimes based on the automatic detections;
power on, based on an auto detection backend of MIPI camera module drivers, a physical MIPI camera; and
match, based on the auto detection backend, at least one of a device identifier or a module identifier of the physical MIPI camera to a first ACPI description of the ACPI descriptions.

36. The article of manufacture of claim 35, wherein the computer-readable instructions are to cause one or more of the at least one programmable circuit to load, based on a driver loader of the virtual MIPI camera module driver, the corresponding MIPI camera driver runtimes.

37. The article of manufacture of claim 36, wherein the computer-readable instructions are to cause one or more of the at least one programmable circuit to build, based on the driver loader, a connection to a MIPI camera module corresponding to the at least one of the device identifier or the module identifier of the physical MIPI camera.

38. The article of manufacture of claim 35, wherein the MIPI camera modules are included in hardware of respective ones of a plurality of MIPI cameras, and the MIPI camera module drivers correspond respectively to the MIPI camera modules.

39. The article of manufacture of claim 35, wherein the first ACPI description includes the at least one of the device identifier or the module identifier of the physical MIPI camera.

40. The article of manufacture of claim 39, wherein the at least one of the device identifier or the module identifier is at least one of a first device identifier or a first module identifier that is unique to the physical MIPI camera, and a second ACPI description of the ACPI descriptions includes at least one of a second device identifier or a second module identifier of a second physical MIPI camera including a same image sensor as the physical MIPI camera.

41. The article of manufacture of claim 35, wherein the auto detection backend is implemented based on an EvtDevicePrepareHardware function, the EvtDevicePrepareHardware function to be called by an operating system (OS) after assignment of a hardware resource.

42. The article of manufacture of claim 41, wherein the hardware resource includes at least one of a general-purpose input/output or an I2C resource.

43. The article of manufacture of claim 35, wherein an installation file of the virtual MIPI camera module driver includes the at least one of the device identifier or the module identifier of the physical MIPI camera.

44. A method comprising:
automatically detecting, based on a virtual Mobile Industry Processor Interface (MIPI) camera module driver, MIPI camera modules associated with Advanced Configuration and Power Interface (ACPI) descriptions stored in a virtual MIPI camera module of a basic input/output system (BIOS);
loading, based on the virtual MIPI camera module driver, corresponding MIPI camera driver runtimes based on the automatic detecting;
powering on, based on an auto detection backend of MIPI camera module drivers, a physical MIPI camera; and
matching, based on the auto detection backend, at least one of a device identifier or module identifier of the physical MIPI camera to a first ACPI description of the ACPI descriptions.

45. The method of claim 44, including:
loading, based on a driver loader of the virtual MIPI camera module driver, the corresponding MIPI camera driver runtimes; and
building, based on the driver loader, a connection to a MIPI camera module corresponding to the at least one of the device identifier or the module identifier of the physical MIPI camera.
